(19) United States
(12) Patent Application Publication
(10) Pub. No.: US 2010/0271534 A1
(43) Pub. Date: Oct. 28, 2010

(54) DOCUMENT CAMERA

(76) Inventor: Rein-Wein LIN, Chung Ho City (TW)

Correspondence Address: Muncy, Geissler, Olds & Lowe, PLLC, 4000 Legato Road, Suite 310, FAIRFAX, VA, 22033, US

(21) Appl. No.: 12/512,746

(22) Filed: Jul. 30, 2009

(30) Foreign Application Priority Data
Apr. 22, 2009 (TW) 98113374

(51) Int. Cl. H04N 5/225

(52) U.S. Cl. 348/340; 348/E05.024

(57) ABSTRACT

A document camera includes a liquid lens and an extended depth of field (referred to as EDoF) module. The liquid lens adjusts its diopter value in accordance with a voltage value provided by a control circuit, and is used to form an image with a longer image distance from an object with a shorter image distance. The object and the image both are located at the same side of the liquid lens. The EDoF module is located behind the liquid lens to process an image by using a wavefront coding technique, and comprises a wavefront encoder used for performing wavefront coding onto the image; a signal processor for converting the image which has been wavefront-coded into digital signals; and a digital image processor for converting the digital signals into image signals.

### RELATED APPLICATIONS

This application claims priority to Taiwan Application Serial Number 98113374, filed Apr. 22, 2009, which is herein incorporated by reference.

### BACKGROUND

1. Field of Invention

The present invention relates to a document camera. More particularly, the present invention relates to a document camera capable of extending the depth of field.

2. Description of Related Art

With the development of technologies, a document camera has been applied to various fields from consumer products to high-tech products since appearing in the market, and thus the application of the document camera is quite broad. The document camera is generally applied in a large meeting for enlarging a target during a speech by using a projection method; or applied on a commercial projection-type screen or television for making a real-time display based on the contents of presentation.

The document camera is a relatively convenient projection tool, which does not need to transform a target desired be presented into an electronic image or text file in advance, but can directly show the target on a projection screen. Therefore, the document camera can reduce the time for preparing the presentation data, and display the real-time changes of the target, and thus is quite a convenient tool.

Most of the focusing techniques adopted by the lenses of conventional document cameras need to search for better image resolution by moving the lenses, thereby achieving the object of focusing. However, the step of moving the lens requires the collaboration of many precision electronic machines, and thus the design thereof is relatively complex and costly. Further, moving the lens takes quite a little of time, so that a user has to take some time to wait for the document camera to focus.

In order to improve the aforementioned problem, this industry generally uses an extended depth of field (EDoF) technique to avoid moving the lens for focusing. The so-called depth of field is the amount of distance between the nearest and farthest objects that appear in acceptably sharp focus in an optical system. The EDoF technique extends a depth of field of an optical system to enable a lens to capture a clear image whenever an object to be photographed is placed within the depth of field.

Although the EDoF technique is helpful for extending the depth of field, yet it still has its limitation. Concretely speaking, the EDoF technique is not suitable for use in the cases of smaller object distance. Among the known techniques, the depth of field applicable to the EDoF technique generally ranges from tens centimeters to tens meters, and ideally, the maximum depth of field is infinite. For example, an OV3642 Color CMOS QXGA (3.1 Megapixel) camera chip made by OmniVision Technologies Inc. is applicable to a depth of field from 20 cm to infinite. Thus, it can be known that the EDoF technique is not applicable to the object distance smaller than the lower limit such as 20 cm.

When being under application, the document camera is often under a situation of which the object distance is smaller than the lower limit of depth of field applicable to the aforementioned EDoF technique. When the EDoF technique cannot be used, the document camera still has to rely on moving the lens for focusing, thus not only having complex design and high cost, but also taking time for focusing.

In view of the forgoing, there is a need to provide a novel document camera which can apply the EDoF technique to extend its depth of field, and is suitable for use in the situation of which the object distance is smaller than the lower limit of depth of field applicable to the EDoF technique.

### SUMMARY

An aspect of the present invention is to provide a document camera using an EDoF technique collaborating with a close up element to extend its depth of field and break the limitation of short object distance in the EDoF technique, thereby replacing the conventional focusing technique of moving a lens.

A document camera includes a liquid lens and an EDoF module. The liquid lens is electrically connected to a control circuit, and a diopter value of the liquid lens is adjusted in accordance with a voltage value provided by the control circuit.

The liquid lens is used to form an image by using light reflected from an object, and the object and the image both are located at the same side of the liquid lens, and an object distance between the object and the liquid lens is shorter than an image distance between the image and the liquid lens. In other words, the liquid lens can form an image with a longer image distance from an object with a shorter image distance.

The EDoF module is coupled to the liquid lens for capturing the image formed by the liquid lens. The EDoF module uses a wavefront coding technique to process the image captured.

The EDoF module includes a wavefront encoder, a signal processor and a digital image processor. The wavefront encoder is used for performing wavefront coding onto the image. The signal processor is used for converting the image which has been wavefront-coded into digital signals. The digital image processor is coupled to the signal processor for converting the digital signals into image signals.

In one embodiment, the EDoF module further includes a plurality of lenses coupled to the wavefront encoder.

In another embodiment, the signal processor includes a sensor and an analog-to-digital converter. The sensor is used for converting light intensities of the image which has been wavefront-coded into analog signals. The analog-to-digital converter is electrically connected to the sensor for converting the analog signals to the digital signals.

In another embodiment, the digital image processor includes a decoder. The decoder is electrically connected the signal processor for decoding the digital signals.

In the embodiments, the EDoF module has a lower limit of depth of field, and the diopter value of the liquid lens is adjusted to make a distance between the object and the EDoF module greater than the lower limit of depth of field. In one embodiment, the distance between the object and the EDoF module is greater than 1 m and smaller than 1Om by adjusting the diopter value of the liquid lens.

It can be known from the above embodiments that the document camera may use the EDoF module to extend the range of its depth of field, and form an image with a longer image distance from an object with a shorter image distance by collaborating with the liquid lens of which the diopter value can be adjusted, thereby breaking the limitation of short object distance in the EDoF module.

It is to be understood that both the foregoing general description and the following detailed description are examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 is a schematic diagram showing the structure of a document camera according to an embodiment of the present invention; and

FIG. 2 is a schematic diagram showing the function of the document camera depicted in FIG. 1.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

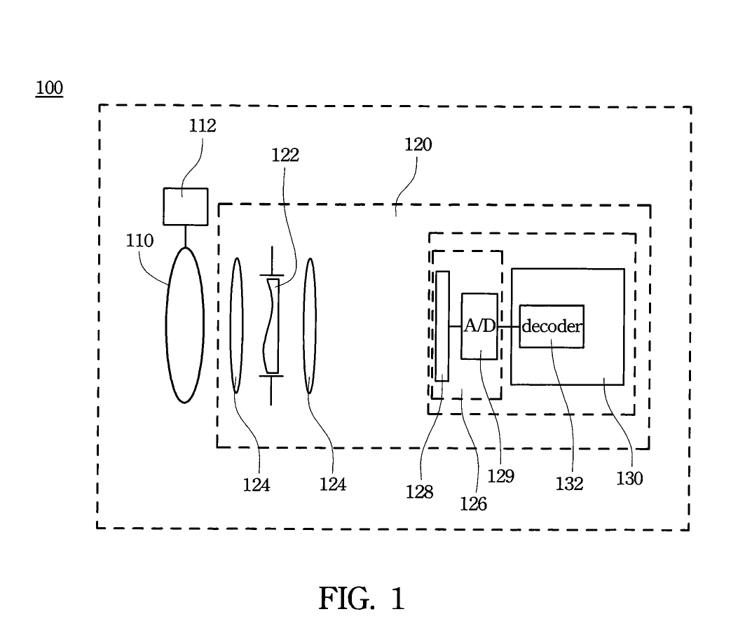

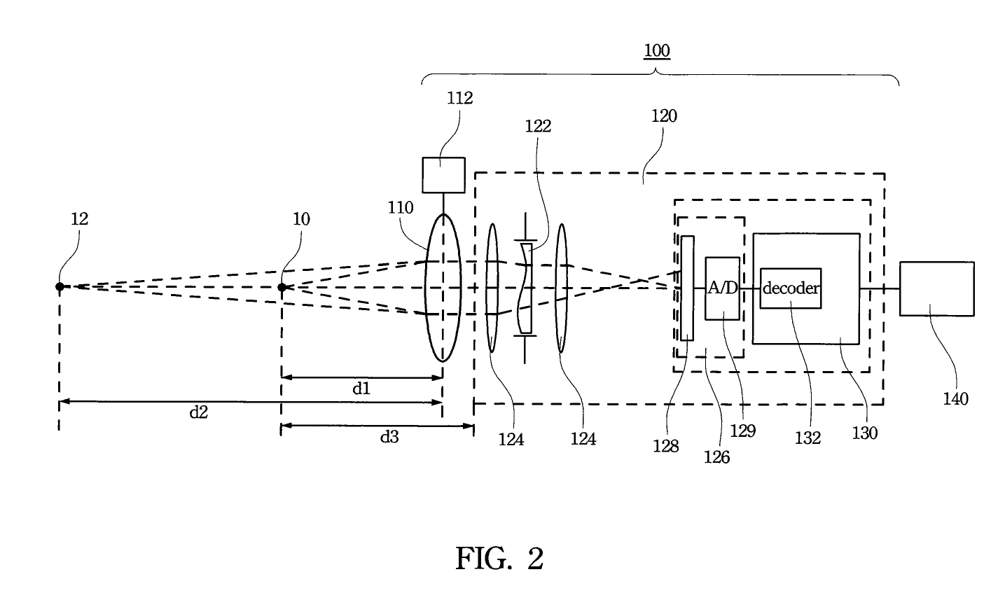

Referring to FIG. 1 and FIG. 2 simultaneously, FIG. 1 is a schematic diagram showing the structure of a document camera 100 according to an embodiment of the present invention; and FIG. 2 is a schematic diagram showing the function of the document camera 100. The document camera 100 is used to capture the image of an object 10 placed in front thereof, and transmits the image to an external display apparatus 140 such as a television, a projector or a computer screen, etc.

The document camera 100 includes a liquid lens 110 and an EDoF module 120 which are coupled to each other. The EDoF module 120 is used to extend the depth of field of the document camera 100. Thus, as long as the object 10 is placed within the range of the depth of field of the document camera 100, the document camera 100 can capture a cleat image of the object 10 without needing to move its lens. The liquid lens 110 is used to project the image of the object 10 with a shorter object distance onto a spot at a father distance, thereby increasing the applicable range of the EDoF module 120. Hereinafter, the respective components and their functions are explained.

The liquid lens 110 is a lens having an adjustable diopter value. An external voltage is applied to adjust the material structure inside the liquid lens 110, thereby changing the diopter value of the liquid lens 110, further changing its focal length. In one embodiment, the liquid lens 110 is electrically connected to a control circuit 112. The control circuit 112 supplies a voltage to the liquid lens 110, and changes the diopter value of the liquid lens 110 by changing the voltage.

There are many types of liquid lens 110. In one embodiment, an ARCTIC 416 lens manufactured by French company Varioptic is used as the liquid lens 110, and its diopter value ranges between −5 (m⁻¹) and 13 (m⁻¹).

The liquid lens 110 is used to form an image 12 by using light reflected from the object 10, and the object 10 and the image 12 are located in front of the liquid lens 110. The distance between the object 10 and the liquid lens 110 is an object distance d1, and the distance between the image 12 and the liquid lens 110 is an image distance d2, wherein the object distance d1 is smaller than the image distance d2. In one embodiment, the focal length of the liquid lens 110 can be adjusted to form the image 12 at a spot that is father from the liquid lens 110 than the object 10.

In one embodiment, the liquid lens 110 is disposed in front of the EDoF module 120, i.e., the liquid lens 110 is located between the EDoF module 120 and the object 10. Therefore, the EDoF module 120 is used to capture the image 12 formed by the liquid lens 110, and to perform wavefront coding onto the image so as to generate a digital image.

The depth of field of the EDoF module 120 is limited within a range. In order to enlarge the range applicable to the EDoF module 120, the liquid lens 110 is used to form the image 12 within the range of depth of field of the EDoF module 120 from the object 10 located outside the range thereof. Concretely speaking, the diopter value of the liquid lens 110 can be adjusted to make a distance d3 between the image 12 and the EDoF module 120 greater than the lower limit of depth of field of the EDoF module 120.

In one embodiment, the diopter value of the liquid lens 110 can be adjusted to make the distance d3 between the image 12 and the EDoF module 120 greater than 1 m. Ideally, the upper limit of the distance d3 between the image 12 and the EDoF module 120 is infinite, and can be 10 m in actual applications.

The EDoF module 120 uses a wavefront coding technique to encode light information, thereby processing the image 12 captured by using a digital method, such as a decoding technique of signal processing. Detailedly speaking, the wavefront coding technique inserts a wavefront encoder 122 such as a phase mask in an optical system to perform phase transformation on the incident light, thereby obtaining another optical transfer function or point diffusion function. Within the range of depth of field, this new optical transfer function or point diffusion function does not change or is insensitive to the change of object distance, thus forming vague middle images. Thereafter, these middle images are decoded and converted to a clear final image. The related operation principle of the EDoF module 120 can be referred to a document such as “Extended depth of field through wave-front coding”, Edward R. Dowski, Jr. and W. Thomas Cathey, Applied Optics, April 1995, which is herein incorporated by reference.

In one embodiment, the EDoF module 120 includes the wavefront encoder 122, a signal processor 126 and a digital image processor 130.

The wavefront encoder 122 is disposed behind the liquid lens 110 for performing wavefront coding onto the image 12. In one embodiment, the wavefront encoder 122 is coupled to a plurality of lenses 124, so as to achieve the efficacy of the wavefront encoder 122.

The signal processor 126 is disposed behind the wavefront encoder 122 for converting the image 12 which has been wavefront-coded into digital signals. The signal processor 126 includes a sensor 128. The sensor 128 is used to receive the image 12 which has been wavefront-coded, and convert light intensities of the image 12 into analog signals. In one embodiment, the signal processor 126 may include an analog-to-digital converter 129. The analog-to-digital converter 129 is electrically connected to the sensor 128 for converting the analog signals to the digital signals.

The digital image processor 130 is electrically to the signal processor 126 for converting the digital signals into image signals. The digital image processor 130 can be connected to the external display apparatus 140 for transmitting and displaying the image signals on the external display apparatus 140.

In one embodiment, the digital image processor 130 has a built-in decoder 132. The decoder 132 is electrically connected the signal processor 126 to decode the digital signals for the subsequent process.

The digital image processor 130 and the signal processor 126 of the EDoF module 120 can be implemented on the same circuit such as an integrated circuit or a chip.

It can be known from the aforementioned embodiments that the document camera 100 uses the EDoF module 120 to extend its depth of field. The document camera 100 uses the liquid lens 110 which can adjust its diopter value and is disposed in front of the EDoF module 120, so that the object 10 with a shorter object distance is projected as the image 12 with a longer image distance, thereby extending its depth of field.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A document camera, comprising:
a liquid lens electrically connected to a control circuit, wherein a diopter value of the liquid lens is adjusted in accordance with a voltage value provided by the control circuit, and is used to form an image by using light reflected from an object, and the object and the image both are located at the same side of the liquid lens, and an object distance between the object and the liquid lens is shorter than an image distance between the image and the liquid lens; and
an extended depth of field (EDoF) module coupled to the liquid lens for capturing the image, wherein the EDoF module uses a wavefront coding technique to process the image, the EDoF module comprising:
a wavefront encoder for performing wavefront coding onto the image;
a signal processor for converting the image which has been wavefront-coded into digital signals; and
a digital image processor for converting the digital signals into image signals.

2. The document camera as claimed in claim 1, wherein the EDoF module further comprises:
a plurality of lenses coupled to the wavefront encoder.

3. The document camera as claimed in claim 1, wherein the signal processor comprises:
a sensor for converting light intensities of the image which has been wavefront-coded into analog signals; and
an analog-to-digital converter electrically connected to the sensor for converting the analog signals to the digital signals.

4. The document camera as claimed in claim 1, wherein the digital image processor comprises:
a decoder electrically connected the signal processor for decoding the digital signals.

5. The document camera as claimed in claim 1, wherein the EDoF module has a lower limit of depth of field, and the diopter value of the liquid lens is adjusted to make a distance between the object and the EDoF module greater than the lower limit of depth of field.

6. The document camera as claimed in claim 1, wherein the distance between the object and the EDoF module is greater than 1 m and smaller than 10 m by adjusting the diopter value of the liquid lens.
